(19) United States
(12) Patent Application Publication
(10) Pub. No.: US 2007/0005800 A1
(43) Pub. Date: Jan. 4, 2007

(54) METHODS, APPARATUS, AND COMPUTER PROGRAMS FOR DIFFERENTIATING BETWEEN ALIAS INSTANCES OF A RESOURCE

(75) Inventors: Andrew David Banks, Romsey (GB); Gavin David Beardall, Winchester (GB); Brian Clive Homewood, Winchester (GB); Ian Charles Vanstone, Southampton (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/425,736

(22) Filed: Jun. 22, 2006

(30) Foreign Application Priority Data
Jun. 30, 2005 (GB) 0513393.9

(51) Int. Cl. G06F 15/173

(52) U.S. Cl. 709/238

(57) ABSTRACT

To differentiate between alias instances of a resource, rank values are assigned to message queues or their respective queue managers to enable differentiation between a highest-ranked message storage location and its lower-ranked alias. This allows a message routing process to make an appropriate selection between a target message queue and an alias for the queue, avoiding the potential problem of messages being delayed by repeated passing between alias queues of gateway queue managers. The potential problem may arise where alias queues are provided for workload sharing and the routing process does not inherently differentiate between a target queue, an alias, and a backup. The solution is to define which queues can be selected on rank values assigned to the queues or their queue managers, and set selection preferences as priority attribute values assigned to the queues or queue managers.

### FIELD OF THE INVENTION

The present invention relates to communication within a data processing network, and in particular provides methods, apparatus, and computer programs for differentiating between a first instance of a resource and alias instances of the resource, for optimal routing and improved communication efficiency.

### BACKGROUND

Clustering of data processing resource within a network allows a number of resource managers or other resources to operate in a similar manner to a single system except with improved availability and performance. Some clustering solutions provide workload balancing and parallel processing, and clusters provide simplified administration compared with merely increasing the numbers of resource managers without use of managed clusters.

For example, in a massaging network, a message queue manager which receives incoming messages may pass some messages to other queue managers within its cluster to share the processing workload and improve performance. This sharing may be invisible from outside the cluster. Each queue may have one or more alias queues to enable workload sharing and to simplify routing via proxies, such as at the interface between two network domains. In this way, clusters of queue managers or other resource managers provide high availability and performance.

In addition to the provision of aliases, it is known to provide backup resources in a data processing network, for failover recovery of a first resource. In a messaging network, some or all queue mangers may be associated with a respective backup queue manager that is available to take over the event of queue manager or connection failure. Such backup queue managers are not intended to be used unless the primary queue manager is affected by a failure, in part because a change of target after every message would be problematic for many applications,

However, the inventors of the present invention have identified problems for such clustered resource manager environments, and these problems need to be addressed before clustering can achieve desired performance levels.

One problem that can arise is that messages may be passed repeatedly between alias queues managed by gateway queue managers of a cluster, resulting in undesirably delayed progress of the messages to their target destinations. Unless this problem is addressed, adding more gateway queue managers to a clustered queue manager environment will fail to achieve desired performance improvements, because each new alias of a target queue increase the opportunity to route the message inappropriately. This problem may arise whenever routing messages to a target destination via intermediate storage locations such as message queues or database tables, if the intermediate locations include more than one alias for the target.

A particular exemplary scenario is where two overlapping clusters of queue managers pass messages between the clusters via gateway queue managers, and multiple gateway queue managers are provided for backup and/or load sharing. If each gateway queue manager holds an alias queue for a target queue, for receiving messages intended for a destination queue within one of the clusters, a message received onto one of the alias queues may be passed to another alias on a second gateway queue manager, and then back again, instead of being passed to the intended destination queue at the earliest opportunity. Inappropriate selection of an alias queue may recur if a simple round-robin queue selection algorithm is used for route determination.

This potential problem can be shown by referring to the example cluster network of FIG. 1, in which two gateway queue managers QM1 (201) and QM3 (203) link and two clusters A (301) and B (302). Although not all of the queue managers within clusters A and B are shown in FIG. 1, the figure shows both of the gateway queue managers QM1 and QM3 holding an alias (Q1-A) for a destination queue (Q1) on target queue manager QM2. A message sent by a first application program 10 and having a target destination Q1 within cluster B may be transferred by a queue manager QM0 within the first cluster A to an alias queue A1-A on one of the gateway queue managers QM1 or QM3. This selection of an alias queue may be a round-robin selection to simplify workload sharing.

Let us assume that QM1 was selected. Since the alias queue Q1-A on QM1 is not the real target, the message needs to be moved on, and so queue manager QM1 selects one of the two visible instances of Q1 (i.e., selects either the real destination Q1 on QM2 and the alias Q1-A on QM3). If the real destination queue Q1 on queue manager QM2 is selected, the transfer to the target queue manager is completed successfully; but the queue manager QM1 could equally have selected the alias queue on the backup gateway queue manager QM3. In this latter case, QM3 is also faced with a decision about which instance is Q1 to choose, and could choose a queue instance on QM1 instead of the target QM2. In this way, because of the lack of differentiation between a target and its aliases, a message could spend some time being moved between one gateway-queue manager and the next before being routed correctly.

### SUMMARY

A first aspect of the present invention provides a data processing apparatus for use in message routing within a data processing network. A route determination component within the apparatus includes means for comparing respective hop-count-independent rank values assigned to each of a set of alternative message storage locations, and means for using the comparison of rank values to select one of the set of alternative message storage locations for routing a message. The route determination component is preferably implemented in a messaging manager computer program.

The apparatus can be used for selection of a highest rank message storage location among a plurality of message storage locations, such as to select a target queue in preference to lower-rank aliases of the target queue, for improved message routing. The assignment of rank and selection may be applied to the queue itself, to a queue manager program associated with the queue, or to a message channel such as a defined communication path between queue managers. The ‘target’ in this context may be a final target destination or a next hop in an asynchronous messaging network in which a route determination is performed for each hop to a next message repository, i.e., each hop starting from a first message repository associated with a sender application via intermediate network nodes to a destination repository associated with a target application.

The apparatus can be used to route messages appropriately through a set of overlapping administrative domains of a network, such as a network in which aliases for a message storage location are provided at gateway resource managers between the domains. The gateway resource managers act as proxies for a resource manager in the target domain. Each of two overlapping domains contains a cluster of resource managers comprising the gateway resource managers and at least one other resource manager. A network administrator may set the rank values, ensuring that the higher values are closest to the target destination. This will discourage messages from passing to network nodes that are no closer to the message's target and encourage route selections that make real progress towards the final target destination. In this way, an administrator is able to impose directional control on an automated message routing process.

Enabling an administrator to control the path that messages take through connected clusters of resource managers enables the administrator to ensure that no loops are formed in the path and that messages are not passed back-and-forth between alias message repositories. Additionally, having defined a set of rank values, the administrator is preferably able to change rank values in response to identification of problems affecting the flow of messages, by increasing the rank of one message queue or queue managers relative to another to stop messages flowing in an undesirable direction across a connection.

Although hop count comparisons can be useful for route selection and do not require administrators to set rank definitions, hop counts do not inherently differentiate between an alias queue and the real target queue. In contract, an assigned rank value can be used to differentiate an alias during a route determination. Hop counts are defined by the network topology, whereas greater flexibility is possible when setting rank values.

There are other disadvantages associated with hop count mechanisms. Known mechanisms require information about the remaining hops to be carried with a message, and typically require a limit to be set on the maximum number of hops allowed, such as in TCP/IP. The number of hops performed can become arbitrarily large as systems use arbitrary choices to discover the least hop routes through the network. Inevitably, some messages take unnecessarily long routes through the set of network nodes and some may exceed their hop counts, resulting in their non-delivery. The potential problem of bouncing between alias queues will tend to increase the risk of message loss that results from the hop count limit. Additionally, it can be difficult to ensure that hop count information stored at each node or held within a message remains valid when the network configuration changes, and propagation of test messages for optimal-route discovery undesirably adds to the load on the network.

A second aspect of the present invention provides a method for routing messages within a data processing network, including the steps of: comparing respective hop-count-independent rank values assigned to each of a set of alternative message storage locations; and using the comparison of rank values to select one of the set of alternative message storage locations for routing a message. In one embodiment of the invention, a set of message storage locations is identified in which each location is a potential next location to which the message could be transferred. For example, the set of locations may include a target location and one or more aliases for the target location. The rank values are compared to identify and select the most appropriate next location.

A further aspect of the invention provides a method for managing routing of messages in an asynchronous messaging network. The method comprises: identifying a set of alternative message storage locations comprising a target location and one or more aliases for the target location; and assigning respective rank values to the message storage locations within the set, including assigning a higher rank value to the target location than the aliases. The rank values can be applied when selecting a message storage location during routing of the message, for preferential selection of the target location. The method can be applied to enable selection between a number of alternative next-hop locations for a message, the step of selecting between alternative locations being repeatable after each hop.

In a first embodiment, rank values are strictly applied such that a message can only be routed from a first message storage location to a second message storage location if the rank value of the second message storage location is higher than the rank value of the first message storage location. This can avoid messages bouncing between multiple alias locations.

In one embodiment of the invention, the higher rank of a target relative to its aliases is combined with a complementary higher prioritization of a target resource manger relative to a backup resource manager. This provides preferential selection of the target resource manager relative to the backup resource. In a clustered queue manager environment such as referred to above, the priority values ensure that a backup queue manager within a cluster is selected when the corresponding target queue manager cannot be reached from a current message storage location (for example, from a selected alias queue of a gateway queue manager). This combination of a rank attribute, which is strictly applied, and a priority attribute (a preference) enables message routing to differentiate between a target location and its aliases and backups, to combine the benefits of optimized routing and the enhanced availability of backup systems. Route determination according to this embodiment of the invention can avoid the two potential problems of bouncing of messages between alias message storage locations on gateway resource managers and incurring delays updating the primary resource manager because of inappropriate routing of a message to a resource manager's backup prior to delivery to the primary resource manager.

The set of message storage locations may comprise a target message queue managed by a first queue manager in a cluster of queue mangers, and one or more aliases for the target queue. The aliases are managed by respective ones of a plurality of gateway queue managers of the cluster. The invention is implementable by providing a rank attribute that can be set for each instance of a queue by a system administrator, or in another embodiment the rank attribute can be set automatically based on a combination of administrator-defined preferences and network characteristics. This differs from a route determination based on hop count, which determines a route by selecting the smallest number of intermediate message transfers between points within a network, because the hop count does not inherently differentiate a target from its aliases and backups, and because an administrator may use the invention to set a higher rank and priority for some queue managers than others without limiting to a determination of ‘hope count to target destination’. For example, both rank and priority attributes may be set for each target queue, alias queue and backup queue in a clustered queue manager environment to enable optimal message route selection.

Alternatively, an asynchronous messaging environment may be implemented using database tables as intermediate storage locations between sender and receiver processes. In this case, the et of message storage locations may comprise a target and alias database tables.

### BRIEF DESCRIPTION OF DRAWINGS

Embodiments of the present invention are described below in more detail, by way of example, with reference to the accompany drawings, in which:

FIG. 1 shows a clustered queue manager environment in which two gateway queue managers each hold aliases for a destination queue, according to the prior art;

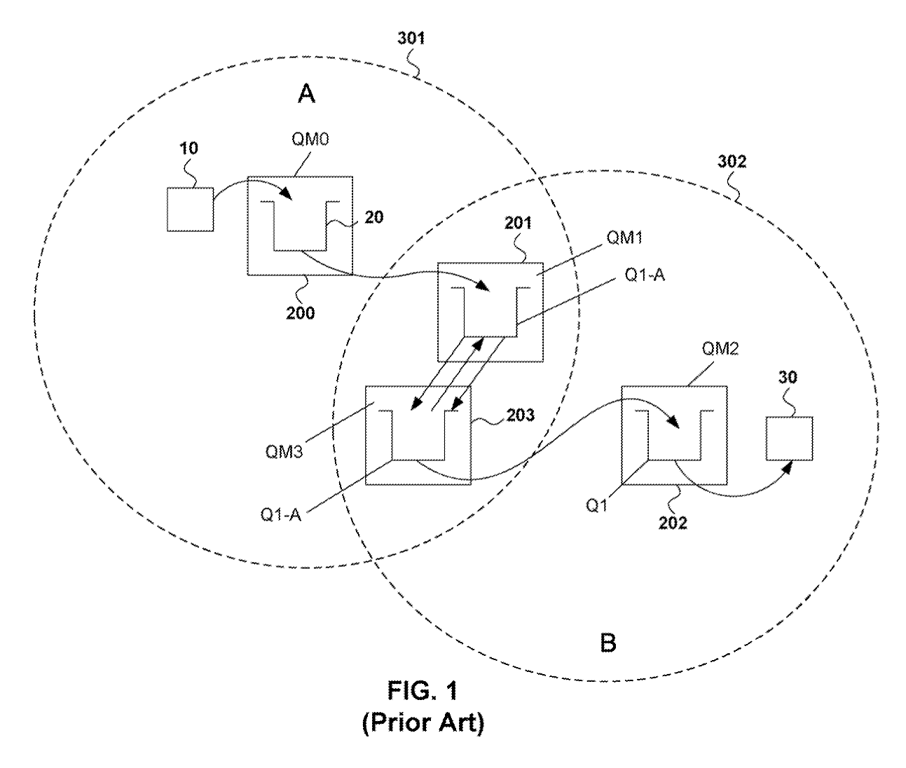

FIG. 2 shows a clustered queue manager environment in which a rank attribute value is assigned to each alias queue on a gateway queue manager, and a higher rank attribute value is assigned to the target queue on a separate queue manager, for queue selection according to an embodiment of the invention;

FIG. 3 shows a clustered queue manager environment in which rank and priority values have been assigned to a target queue and its backup and alias queues, according to an embodiment of the invention; and

FIG. 4 shows a routing process according to an embodiment of the invention.

### DETAILED DESCRIPTION

As noted above, the present invention is implementable in a number of data processing and communication networks in which messages are sent to a target destination via intermediate storage locations such as message queues or database tables. If the message storage locations include aliases and backups for a target message storage location, the invention can be used to enable efficient differentiation between the target, aliases, and backups for efficient message routing. Described below is an exemplary solution in a clustered queue manager environment. Messages are transmitted asynchronously across a network from a sender application program to a receiver application via interoperating messaging manager programs, as a sequence of queue-manager-controlled hops between queues. An outgoing message queue managed by a messaging manager program is referred to below as a transmission queue, whereas the receiver application's input queue is referred to as a target destination queue.

As is known in the art, asynchronous messaging enables communication between application programs in a distributed heterogeneous network, and so the sender application program may run on a different operating system from the receiver. The sender and receiver applications may run on data processing systems that are remote from each other, in for example, different countries or in the same building. Asynchronous messaging networks now extend to low-storage, bandwidth-limited devices as well as high-end server computers. Messaging manager products such as IBM Corporation's WebSphere MQ message queue manager programs handle the complex processes including routing, message format transformation, and transactional data transfers that are involved in assured once-only delivery of each message from the sender to the receiver. IBM's WebSphere products also include message broker products implementing a publish/subscribe communication methodology for subscription-based routing and filtering of messages. IBM and WebSphere are registered trademarks of International Business Machines Corporation in the US and other countries.

Adding more instances of a message queue manager program to a network of connected data processing systems can give a high availability and the ability to employ more processing power for improved messaging performance (scalability). However, more queue managers mean more complexity. Clustering of queue managers helps to manage the complexity and achieve control.

Within a cluster, message queue managers advertise the availability of some of their channels and queues to each other. The knowledge of these resources is shared among a set of queue managers, and the queues and channels belonging to this set forms a cluster. No single physical entity controls the set of queue managers, which avoids exposure to a single point of failure. If a failure occurs, required touring and processing services are still provided by the cluster of queue managers as long as sufficient queue managers and connections remain available.

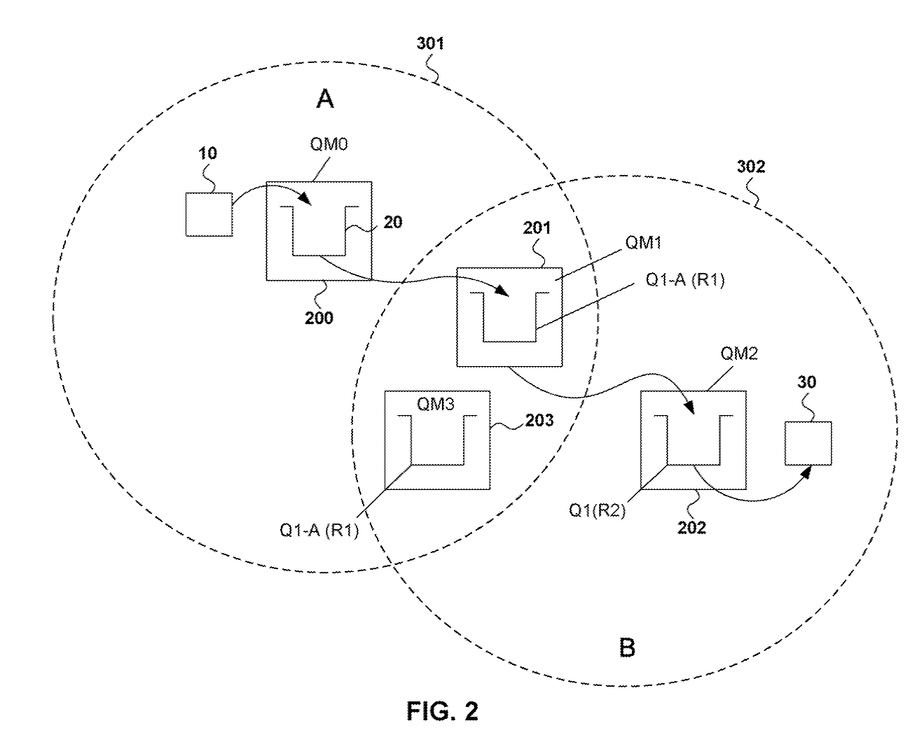

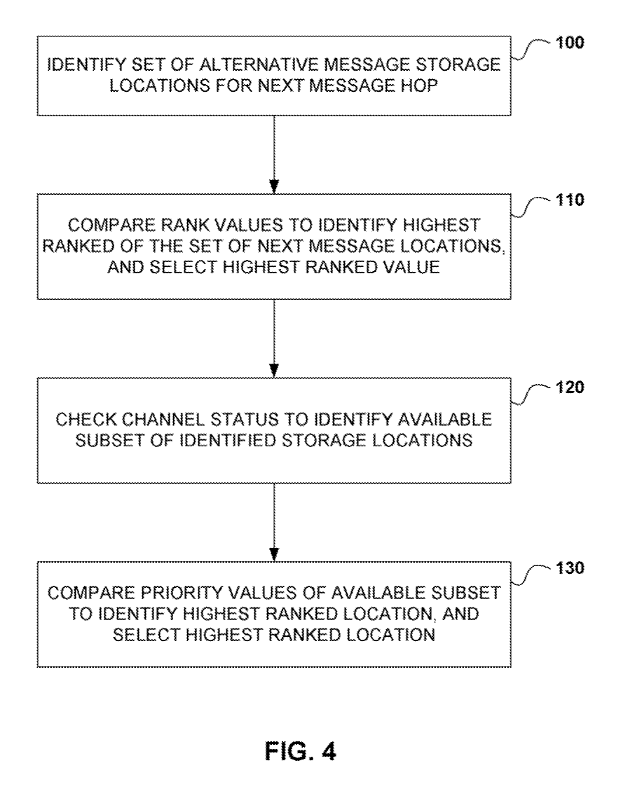

FIG. 2 shows an exemplary network in which two overlapping clusters of message queue managers include two gateway queue managers QM1 (201) and QM3 (203). A first cluster A (301) contains a queue manger QM0 (200) that handles requests from a sender application program 10 to send messages to target queues such as Q1 managed by a remote queue manger QM2 (202) within cluster B (302). Either or both of clusters A and B may contain additional queue managers, perhaps several hundred or even thousands, to those shown in FIG. 2. The target queue Q1 is serviced by a receiver application program 30. When the sender application 10 issues a Put_Message request to send a first message to Q1, the sender application's local queue manager QMO executes a rank-sensitive route determination process (see FIG. 4) to identify an appropriate queue manager and queue as the next hop on route to the target queue, and then places the message on an appropriate local transmission queue 20 for onward transmission to the identified intermediate queue manager. As is know in the art, the identification of possible next hops within the network is based on message queue managers propagating information through the network of queue mangers to enable each queue manger to determine which queue mangers can be reached via which other queue mangers. A sending queue manager is not required to know the full network topology or to know the full route to be followed by a message, but requires knowledge of whether adjacent queue managers provide a route towards the target and whether a communication channel is defined and active for sending messages to the adjacent queue managers. This allows identification of a set of possible next steps through the network, and a route selection is performed to choose between available route options.

In the example of FIG. 2, the route determination process much choose between two queues Q1-A that are aliases for Q1 and are each managed by one of the gateway queue managers QM1 and QM3. Since both alias queues have the same rank attribute value R1, let us assume that a round-robin selection is executed. Alternatively, a number of factors may encourage selection of one gateway queue manager , for example if an administrator specifies that 67% of messages should go to QM1, subject to capacity-based workload management, because QM1 employs a more powerful processor that QM3. Other factors can include, for example, a check of relative performance and link availability for QM1 and QM3, or administrator-controlled disabling of a queue or queue manager. Differences between message transfer costs for the two queue managers may also be taken into account. Workload manager alerts may indicate a preference not to add further messages to a specified queue manager or queue. Other such factors are known in the art.

Let us assume that the alias queue Q1-A on queue manager QM1 is chosen as the next hop. The two queue mangers (QM0 and QM1 implement transactional, assured message transfer from the outbound transmission quite 20 to the alias queue Q1-A (itself a transmission queue), performing any required message format transformation to take account of different operating system requirements. QM1 receives the message, performs a determination (100-103) of where the message should be sent next, stores the message persistently on alias queues Q1-A, and acknowledges the receipt, all within a single transaction.

As mentioned above, queue manager QM1 performs a determination of the next network hop in order to identify a suitable transmission queue. In a conventional system, two of the queues visible to QM1 would appear to be valid targets: the target queue Q1 on queue manager QM2 and the alias queue Q1-A on gateway queue manager QM3. The target and its alias would be indistinguishable in a typical clustered queue manager environment but selection of the latter will not move the message any closer to its intended destination, and simple round-robin selection could result in the message being repeatedly passed between the alias queues on the queue managers.

To ensure that queue manager QM2 is selected rather than QM3, the target queue Q1 has been assigned a higher rank attribute value R2 than the rank value R1 of the alias queue Q1-A on QM3. In the context of the present embodiment, rank values are used within a strict selection rule which prevents messages being passed to a message repository that has a lower or equal rank to the current repository holding the message. Messages can only move in a direction of increasing rank, and increasing rank is assumed to represent progress toward the target destination of the message.

The rank-sensitive route determination process shown in FIG. 4 employs the different rank attribute values to select 110 the target queue Q1 on queue manager QM2. As noted above, rank values are applied strictly in the present embodiment and only queues having a higher rank attribute value than the current intermediate queue A1-A on QM1 are considered acceptable candidates for onward transmission of the message. In the example of FIG. 2, this means that only higher-ranked Q1 on QM2 is considered to be an acceptable candidate, and so Q1 is selected. Queue manager QM1 routes the message to QM2, which places the message on the target queue Q1. The message is now available for retrieval by the targeted receiver application program 30 when that receiver application is ready to process the message. If a plurality of queues are visible which are higher-ranked than the current queue, the highest-ranked one of this set of queues is selected since this is assumed to be the closes to the target.

An alternative use of rank values provides preferential selection of a highest ranked queues or queue manager (QM) but, if the highest-ranked queue or QM is currently unavailable, also enables routing to a queue or QM that is ranked higher than the current queue or QM but is not the identified highest rank queue or QM. This may enable bypassing of a link or QM failure and yet, because only queues and QMs ranked higher than the current queue or QM can be selected, the message has still progressed towards the destination.

In both of the embodiments described above, the rank-sensitive selection 110 only permits messages to be moved to queues (or QMs) having higher rank values. However, backup queue managers and queues are provided and channel status is checked 120, and the route selection supplements the use of rank values with comparison of priority values for differentiating 130 between a primary copy of a queue an backup copies of the queue.

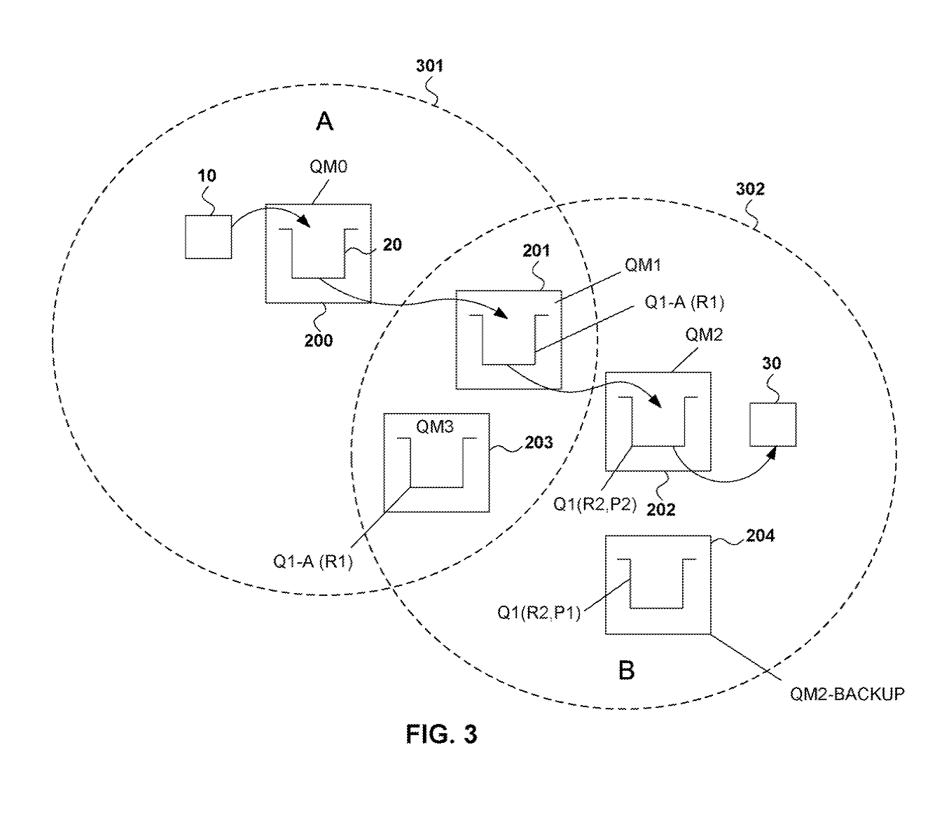

FIG. 3 shows a message queuing network that is equivalent to the network of FIG. 2 except that a backup queue manager QM2-BACKUP (204) is associated with target queue manager QM2 and different priority values are assigned to the target queue QM2 and its backup QM2-BACKUP. Assuming once again that an initial execution of the rank-sensitive route determination process by queue manager QM0 initially selects queue Q1-A on queue manager QM1 for the next communication hop, QM1 is once again required to determine where next to send the message. However, in the network of FIG. 3, QM1 has to select between the two copies of Q1 on the target and backup queue managers QM2 and QM2-BACKUP. To ensure that the target (primary copy of the queue) is consistently updated as quickly as possible, the rank-sensitive route determination process performed as QM1 takes account of the different priority values of the target and backup and preferentially selects the target.

Since the solution of FIG. 3 can be implemented to provide failure recover if QM2 or Q1 is unavailable, a strict rank-sensitive selection (as defined above) can be implemented by QM1 without unnecessary holding up the progress of a message to its target destination. As shown in FIG. 4, rank values are checked 110 when a set of potential next hop destinations are currently available, the priority values are checked to choose 130 one of the available destinations.

The above description explains how rank priority values can be used for optimal messaging routing, such as to identify an optimal route across two administrative domains within a network. In the present embodiment, the Rank and Priority attribute values supplement other attributes that may be used in route determination, examples of which are described above. For example, link availability and performance, relative processing power, workload management techniques, and cost can all be included within a routing determination.

Described below are specific implementations of a messaging system that include rank and priority for attributes for queues and channels, and solutions for setting the attribute values.

In a queue-based implementation that provides workload manager capabilities for enhanced clustering, the definition of a queue is extended to allow rank and priority attribute values to be set (within DEFINE or ALTER operations) by a system administrator.

DEFINE|ALTER QLOCAL |QALIAS|QREMOTE . . . RANK(0:9) PRTY(0:9)

In this example, both Rank and Priority can be any number between 0 and 9, and higher values of RANK() and PRTY() will take precedence over lower values. For example:

ALTER QALIAS(QNAME)RANK(4)

is effective to alter the rank attribute value for alias queue QALIAS(QNAME). DEFINE and ALTER are operations in which priority values can be set. QLOCAL, QALIAS, and QREMOTE are types of queues for which priority values can be set. Additional administrative operations can be included in such expressions, such as setting and changing alias properties (disabling further Puts, specifying which cluster, which queue manager, and the like).

These concepts can also be applied to queue manager aliases, where the destination queue manager rather than the destination queue is chosen. In this case, the values for Rank and Priority also apply to channel definitions which constitute characteristics of the queue managers. For example, a channel to queue manager QMX may be defined with:

DEFINE CHANNEL(TO.QMX)CHLTYPE(CLUSRCVR)RANK(3)

Such a channel to a first queue manager should receive messages in preference to another lower-ranked queue manager having a queue manager alias defined by: DEFINE QMANACER ALIAS(QMX)RANK(2)

Thus, Rank and Priority values can be set as queue or channel attributes at any time by an administrator of the system hosting the target queue or alias queue instance. The values take effect in systems sourcing the message, including intermediate sources, when the Rank and Priority value information for a queue instance has been propagated to those systems. The administrator is not required to set rank values that are consistent with hop counts, and by providing a range of rank values the system provides more flexibility than a two-value system (equivalent to an ‘Alias’ flag and a “Target” flag) and more flexibility than a hop-count-based solution, which is predetermined by the physical characteristics of the network.

Referring again to FIG. 3, let us assume that an administrator wants messages to travel from QM0 to QM2, and that another queue manager QM4 is provided for disaster recover only. QM4 does not normally process any messages. Let us assume that QM4, or its target message queue, is assigned Rank2, whereas QM2, or its target queue, is now assigned Rank3. The messages are initially transferred to a Rank1 alias queue in one of the gateway queue managers QM1 or QM3, and are then passed on to the Rank3 queue of QM2, ignoring the Rank2 queue on QM4. The administrator has the option to change the rank values at any time, such as in response to a communication or system failure. For example, setting Rank4 for the target queue on QM4 will result in messages being transferred to the target queue of QM4 instead of the Rank3 queue of QM2. This example shows the flexibility of the present embodiment, in which more than two rank values are available.

In an alternative embodiment, and administrator defines ultimate target queues and then a rank assignment process performs a semi-automated assignment of rank values between the target and aliases. This involves computing all possible routes and the number of systems between network nodes, and assigning rank values that increase with proximity to the target. The system administrator may still be invited to verify the automatically-assigned rank values.

The administrator, or alternatively a semi-automated assignment process such as mentioned above, also sets the priority values associated with backup queues and systems. The administrator's input is useful in this case because the selection of a backup queue or system can depend on the administrator's intentions for which other tasks will be performed by the backup system. For example, a backup system may be used as a test system until required to take over from a target system that experiences a failure. The administrator can make decisions about allocation of tasks between systems and assign priority values accordingly. For example, a main queue manager may have a local queue with Priority6 and a backup queue manager may have an equivalent local queue defined except with Priority1. The highest priority queue will be chosen if both are valid choices. Thus, the main queue manager will be chosen because of its higher priority, but the backup queue manager will be chosen if the main queue manager fails while the lower-priority backup queue manager has an active channel.

Systems and methods as described above enable setting of a preferred route between interconnected clusters. This is especially useful where a gateway queue manager or similar gateway system could choose between either of two or more message locations, but one location should nevertheless be selected in preference to the others to prevent messages being repeatedly passed between message locations on the gateways. The route chosen within each cluster may be a separate consideration.

When rank attributes are used according to this invention, messages flow between interconnected clusters in a directed way. The rank-sensitive selection 110 can be performed before the channel status is checked 120, width messages being queued if the channel to the target queue manager is not running. Priority values of target and backup systems can be compared 130 after highest ranked systems are identified 110, to select an alternative route when the first-selected channel is not running.

One advantage of the use of rank values according to the invention is that the addition of more gateway queue managers between intersecting clusters can then achieve desired messaging performance improvements, thereby avoiding the performance-limiting problem of repeated bouncing of messages between the gateways.

What is claimed is:

1. A method for using messages within a data processing network, the method comprising:
comparing respective hop-count-independent rank values assigned to each of a set of alternative message storage locations; and selecting, using the comparison of rank values, one of the set of message storage locations for routing a message.

2. The method of claim 1, wherein the comparing step compares a higher rank value assigned to the first message storage location with a lower rank value assigned to an alias for the message storage location, and the selecting step selects the higher ranked first message storage location.

3. The method of claim 1, wherein the step of selecting one of the set of message storage locations comprises selecting a highest ranked location within the set.

4. The method of claim 3, further comprising checking availability of at least one message storage location comprising a highest ranked location within the set and selecting an available message storage location in preference to an unavailable message storage location.

5. The method of claim 3, further comprising the steps of: responsive to identification of a plurality of highest ranked locations within the set, comparing respective priority values assigned to each of said plurality and selecting a highest ranked location having a highest assigned priority.

6. The method of claim 1, wherein the comparing and selecting steps are performed to select a next message storage location along a route to a final destination of the message, and are repeated for a plurality of selections of a next message storage location along the route.

7. The method of claim 1, wherein the set of alternative message storage locations comprises a first message queue and at least one alias for the first message queue.

8. The method of claim 7, for direct routing of a message during transmission from a sender application associated with a message queue manager within a first cluster of queue managers to a target application associated with a message queue manager within a second cluster of queue managers, wherein said first message queue comprises a message queue managed by a queue manager within said second cluster and said at least one alias comprises a message queue managed by a gateway manager between said first and second clusters.

9. The method of claim 1, wherein the set of alternative message storage locations comprises a database structure and at least one alias for the database structure.

10. A method for managing routing of messages in an asynchronous messaging network, the method comprising:
identifying a set of message storage locations comprising a first location and at least one alias for the first location;
assigning respective rank values to the message storage locations within the set, including assigning a higher rank value to the first location than the aliases; and
storing the rank values in association with the message storage locations to enable applying the rank values when selecting a message storage location during routing of the message, for preferential selection of the first location.

11. The method of claim 10, including applying the rank values for routing a message from a current message storage location, wherein the step of applying the rank values includes preventing selection of any message storage location having a rank value that is lower or equal to the rank value of the current message storage location.

12. The method of claim 10, wherein the step of assigning respective rank values to the message storage locations comprises assigning a first rank value to a first message queue and assigning to an alias for the first message queue a rank value that is lower than the first value.

13. The method of claim 10, wherein the step of assigning respective rank values to the message storage locations comprises assigning a first rank value to a first queue manager associated with a first message queue and assigning a rank value lower than the first rank value to at least a second queue manager associated with an alias for the first message queue.

14. The method of claim 10, further comprising the step of assigning respective priority values to the message storage locations within the set, including assigning a higher rank value to a first location than to a backup for the first location.

15. A computer program product for controlling a data processing apparatus, the computer program product comprising a computer usable medium having computer usable program code embedding therein, the computer usable program code comprising computer usable program code configured to compare respective hop-count-independent rank values assigned to each of a set of alternative message storage locations; and computer usable program code configured to select, using the comparison of rank values, one of the set of message storage locations for routing a message.

16. The computer program product of claim 15, wherein the computer usable program code configured to compare respective hop-count-independent rank values compares a higher rank value assigned to the first message storage location with a lower rank value assigned to an alias for the message storage location, and the computer usable program code configured to select one of the set of message storage locations selects the higher ranked first message storage location.

17. The computer program product of claim 15, wherein the computer usable program code configured to select one of the set of message storage locations comprises computer usable program code configured to select a highest ranked location within the set.

18. The computer program product of claim 15, further comprising computer usable program code configured to check the availability of at least one message storage location comprising highest ranked location within the set and select an available message storage location in preference to an unavailable message storage location.

19. The computer program product of claim 15, further comprising computer usable program code responsive to identification of a plurality of highest ranked locations within the set configured to compare respective priority values assigned to each of said plurality and select a highest ranked location having a highest assigned priority.
